(19) United States
(12) Patent Application Publication
(10) Pub. No.: US 2017/0252652 A1
(43) Pub. Date: Sep. 7, 2017

(54) CONTENT PROVIDING METHOD AND CONTENT PROVIDING APPARATUS

(71) Applicant: MINDQUAKE INC., Seoul (KR)

(72) Inventors: Sun Hae KIM, Seoul (KR); Sung Jae HWANG, Seoul (KR)

(21) Appl. No.: 14/784,944

(22) PCT Filed: Sep. 4, 2015
(86) PCT No.: PCT/KR2015/009351

§ 371 Date: Oct. 15, 2015

(51) Int. Cl. A63F 13/67; A63F 13/79; A63F 13/837; G06F 3/0482; A63F 13/497

(52) U.S. Cl. CPC A63F 13/67; G06F 3/0482; A63F 13/497; A63F 13/837; A63F 13/79; A63F 2300/6027; A63F 2300/634; A63F 2300/8076

(57) ABSTRACT

Provided are a content providing method and a content providing apparatus. The content providing method may receive an input on time information about a time at which content is to be provided, may modify the content to prevent a playback time of the content from exceeding the time information, and may provide the modified content.

### TECHNICAL FIELD

The following description relates to a content providing method and a content providing apparatus, and more particularly, to a method and apparatus for modifying and providing content based on input time information.

### RELATED ART

Recently, with the content distribution being active, various types of contents for all ages, particularly, children are being created. Parents are using such contents, etc., to soothe a child or to change concern of a child. In such a circumstance, children desire to utilize corresponding content until the content is terminated. Accordingly, there is a technology for adjusting a playback time of content being provided to children.

### DESCRIPTION OF INVENTION

### Subjects

The present invention provides a method and apparatus that may effectively control a content utilization time of a second user by modifying content based on time information input from a first user and by providing the modified content to the second user.

The present invention also provides a method and apparatus that may induce a second user to suspend a content utilization based on set time information by additionally modifying the content as necessary even while the second user is utilizing the modified content.

### Solutions

According to an embodiment, there is provided a content providing method including receiving an input on time information about a time at which content is to be provided, modifying the content to prevent a playback time of the content from exceeding the time information, and providing the modified content.

The content may include a plurality of sections, and the modifying of the content may include grouping the plurality of sections into at least one group based on features of the plurality of sections and modifying the content based on the at least one group.

The features of the plurality of sections may include information about at least one of contrast, brightness, and tone of images included in the plurality of sections, content description included in the plurality of sections, and tags preset to the plurality of sections.

The modifying of the content may include modifying the content to prevent the playback time of the content from exceeding the time information by excluding at least one section from a plurality of sections included in the content.

The modifying of the content may include modifying the content to dispose a section disposed at a temporally last location among a plurality of sections included in the content, at a last location of the modified content.

The modifying of the content may include controlling a difficulty level of the content based on the time information.

The modifying of the content may include modifying the content to decrease the difficulty level of the content according to an increase in the time information.

The modifying of the content may include controlling the difficulty level of the content by adjusting at least one of the number of enemies that appear in a shooting game, a motion speed of an enemy, and an item providing frequency in a case in which the content is the shooting game, and controlling the difficulty level of the content by adjusting a difficulty level of a question presented in a quiz game and a time limit for solving the question in a case in which the content is the quiz game.

The modifying of the content may include additionally modifying the provided content based on a play pattern of a user performing the provided content.

The modifying of the content may include adding at least one section to the provided content in response to points of the play pattern of the user being greater than preset threshold points.

The modifying of the content may include adding, to the provided content, at least one selection of which a similarity with a current section of content being viewed by the user is greater than a preset threshold ratio.

The modifying of the content may include excluding at least one section from sections included in the content in response to points of the play pattern of the user being less than preset threshold points.

The modifying of the content may include adjusting a difficulty level of the provided content through a comparison between points of the play pattern of the user and preset threshold points.

The modifying of the content may include adding at least one section to the provided content, excluding at least one section from sections included in the provided content, or adjusting a difficulty level of the provided content, in response to an input on modification to the time information.

According to an embodiment, there is provided a content providing apparatus including an interface configured to receive an input associated with content, and a processor configured to modify the content in response to the input. The processor is further configured to receive an input on time information about a time at which content is to be provided, to modify the content to prevent a playback time of the content from exceeding the time information, and to provide the modified content.

### Effects

According to embodiments, it is possible to effectively control a content utilization time of a second user by modifying content based on time information input from a first user and by providing the modified content to the second user.

Also, according to embodiments, it is possible to induce a second user to suspend a content utilization based on set time information by additionally modifying the content as necessary even while the second user is utilizing the modified content.

### BRIEF DESCRIPTION OF DRAWINGS

FIG. 1 illustrates a content providing apparatus according to an embodiment.

FIG. 2 is a flowchart illustrating a content providing method according to an embodiment.

FIGS. 3 and 4 are examples of modifying content according to an embodiment.

FIG. 5 is a flowchart illustrating a content providing method according to another embodiment.

FIG. 6 illustrates an example of a plurality of sections included in content according to an embodiment.

FIGS. 7 through 9 illustrate examples of additionally modifying content according to an embodiment.

FIG. 10 is a block diagram illustrating a configuration of a content providing apparatus according to an embodiment.

### DETAILED DESCRIPTION TO CARRY OUT THE INVENTION

Hereinafter, embodiments will be described with reference to the accompanying drawings. The following specific structural through functional descriptions are provided to simply explain the embodiments and thus, the scope of the embodiments are not limited to the descriptions. It should be apparent to those skilled in the art that various changes and modifications can be made from the following description. Also, reference numerals proposed in the drawings refer to like elements throughout and known functions and structures are omitted.

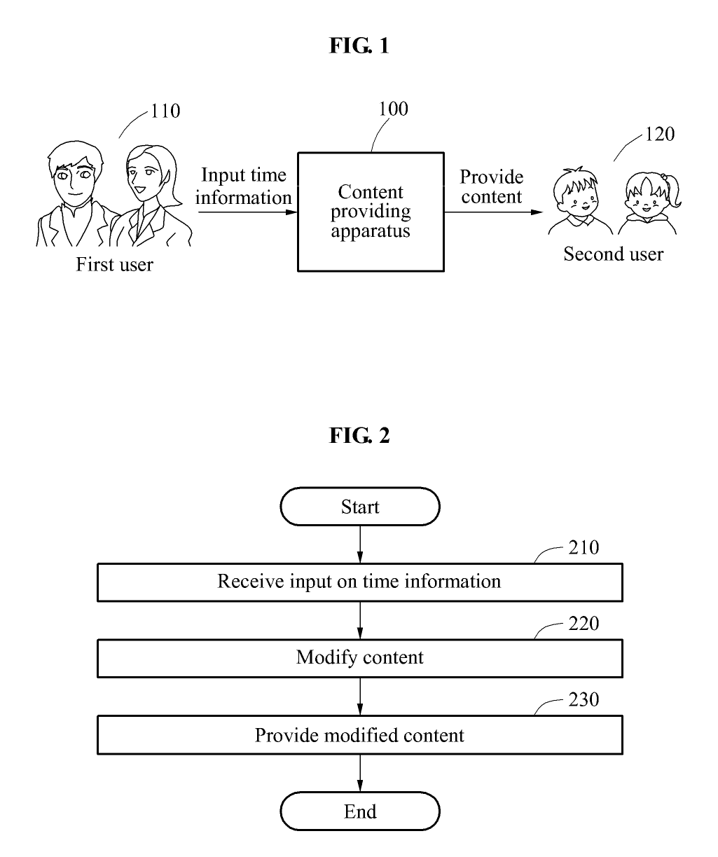

FIG. 1 illustrates a content providing apparatus according to an embodiment.

FIG. 1 illustrates a content providing apparatus 100, a first user 110, and a second user 120. Here, the content providing apparatus 100 refers to a device that may provide contents and may be mounted to a variety of computing devices and/or systems, for example, a smartphone, a tablet computer, a laptop computer, a desktop computer, a television (TV), a wearable device, a smart home system, etc. The contents may indicate various contents having a story that progresses over time. For example, the contents may include a video game, a video, and the like.

The first user 110 may set a condition associated with the content providing apparatus 100. The first user 110 may set time information about a time at which content is to be provided from the content providing apparatus 100. For example, the first user 110, as a parent of the second user 120, may set time information about a time in which the second user 120 is allowed to utilize the content providing apparatus 100.

The second user 120 may receive content from the content providing apparatus 100 based on a preset condition. The second user 120 may receive the content from the content providing apparatus 100 based on a preset time. For example, the second user 120, as a child of the first user 110, may utilize the content providing apparatus 100 within the condition set by the first user 110.

The content providing apparatus 100 may provide the content to the second user 120 based on time information input from the first user 110. The content providing apparatus 100 may not provide the content to the second user 120 beyond the time information. Accordingly, the content providing apparatus 100 may modify the content based on the time information and may provide the modified content to the second user 120. That is, when a playback time of content to be provided exceeds the time information, the content providing apparatus 100 may modify the content and may provide the modified content to the second user 120. Accordingly, since the content provided to the second user 120 is smoothly terminated not to exceed the time information input from the first user 110, the first user 110 may effectively control the content utilization time of the second user 120.

Here, the content providing apparatus 100 may appropriately increase or decrease a plurality of sections that constitutes the content or may adjust a difficulty level of content and accordingly, may modify the content so that the playback time of content may not exceed the time information. Here, the adjusted difficulty level may indicate a difficulty level of a video game that is the content.

Also, the content providing apparatus 100 may additionally modify the content based on a play pattern of the second user 120 that is input from the second user 120 during providing the modified content to the second user 120. Also, in an example in which time information is modified by the first user 110 during providing the modified content to the second user 120, the content providing apparatus 100 may also additionally modify the content based on the modified time information.

FIG. 2 is a flowchart illustrating a content providing method according to an embodiment.

The content providing method according to an embodiment may be performed by a processor provided to a content providing apparatus according to an embodiment.

In operation 210, the content providing apparatus receives an input on time information about a time at which content is to be provided. The content providing apparatus may receive an input on time information from a first user.

In operation 220, the content providing apparatus modifies the content so that a playback time may not exceed the time information.

When the playback time of content exceeds the time information, the content providing apparatus may increase or decrease a plurality of sections that constitutes the content, may adjust a difficulty level of the content, or may apply the increase or the decrease and the adjustment of the difficulty level together.

For example, the content providing apparatus may group a plurality of sections into at least one group based on features of the plurality of sections, and may modify content based on the at least one group. Here, the features of the plurality of sections may include information about at least one of contrast, brightness, and tone of images included in the plurality of sections, content description included in the plurality of sections, for example, description associated with a character included in a corresponding section, and tags preset to the plurality of sections. A tag preset to a section indicates a keyword that represents the corresponding section and may be preset by a content provider or a user.

The content providing apparatus may modify the content so that the playback time of the content may not exceed the time information by excluding at least one section from among the plurality of sections included in the content.

As another example, the content providing apparatus may control a difficulty level of content based on time information. The content providing apparatus may modify the content so that a difficulty level of content may increase according to a decrease in time information. Conversely, the content providing apparatus may modify the content so that a difficulty level of a video game included in content may decrease according to an increase in time information.

In an example in which content is a shooting game, the content providing apparatus may control a difficulty level of content by adjusting at least one of the number of enemies that appear in the shooting game, an energy of an energy, a motion speed of the enemy, an item providing frequency indicating a frequency that an item is provided in a video game, and the like. The content providing apparatus may increase the difficulty level by increasing at least one of the number of enemies, the energy of the enemy, and the motion speed of the enemy or by decreasing the item providing frequency.

In an example in which content is a quiz game, the content providing apparatus may control a difficulty level of content by adjusting a difficulty level of a question presented in the quiz game, a time limit for solving the question, and the like. The content providing apparatus may increase the difficulty level by increasing the difficulty level of the question or by decreasing the limit time.

In operation 230, the content providing apparatus provides the modified content. For example, the content providing apparatus may display the modified content on a display and may play back a sound according to the modified content through a speaker.

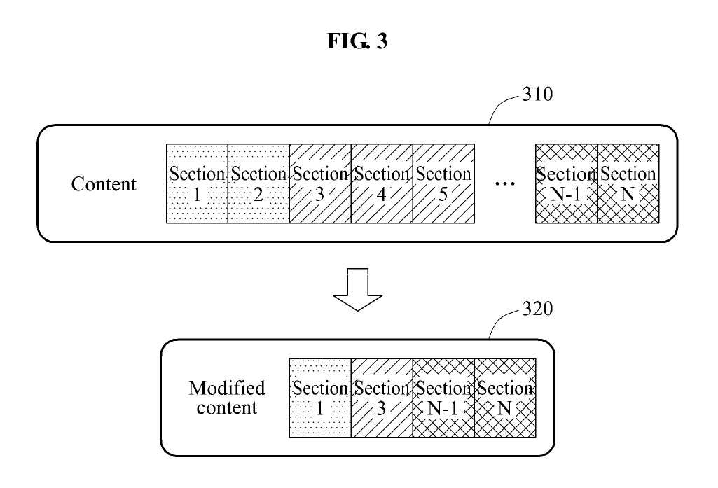

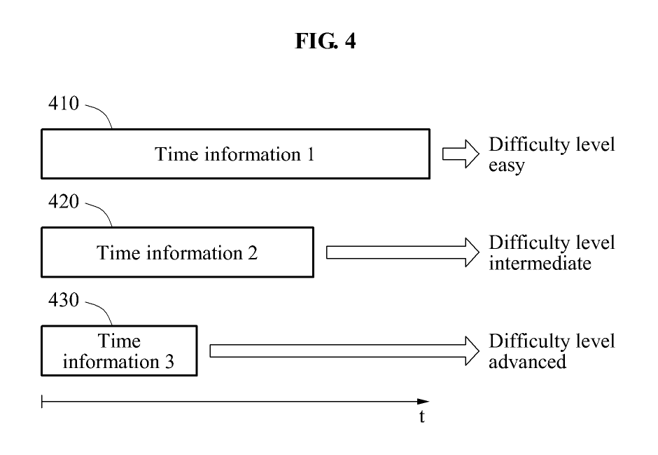

FIGS. 3 and 4 illustrate examples of modifying content according to an embodiment.

FIG. 3 illustrates content 310 representing a before-modification state by the content providing apparatus and modified content 320 representing an after-modification state by the content providing apparatus. Hereinafter, for clarity of description, a situation in which a playback time of the content 310 exceeds time information is assumed.

The content 310 of FIG. 3 may include a plurality of sections, for example, section 1 through section N. The plurality of sections, for example, section 1 through section N may be arranged in temporal order. That is, section 1 may indicate a start section of the content 310 and section N may indicate a last section of the content 310.

In an example in which the content 310 is a video game, the plurality of sections, for example, section 1 through section N, may indicate stages included in the video game. Alternatively, in an example in which the content 310 is a video, the plurality of sections, for example, section 1 through section N, may indicate scenes included in the video.

The content providing apparatus may group the plurality of sections, for example, section 1 through section N, into at least one group based on features of the plurality of sections. The content providing apparatus may group, into a single group, at least one section of which a similarity level between the features of the plurality of sections is greater than a predetermined threshold ratio. In general, mutually adjacent sections are highly likely to include images having similar contrast, brightness, and tone, or to include similar content description. Alternatively, similar tags are highly likely to be set to the adjacent sections. Accordingly, the content providing apparatus may group temporally adjacent sections into a single group. Here, the similarity level may be calculated using a variety of methods based on a design.

For example, among the plurality of sections, for example, section 1 through section N of FIG. 3, section 1 and section 2 may be grouped into group 1, section 3 through section 5 may be grouped into group 2, and section N−1 and section N may be grouped into group k.

The content providing apparatus may generate the modified content 320 by modifying the content 310 based on at least one group, for example, group 1 through group k. Here, a playback time of the modified content 320 may not exceed time information.

The content providing apparatus may generate the modified content 320 by excluding at least one section from among the plurality of sections, for example, section 1 through section N, included in the content 310. Referring to FIG. 3, the modified content 320 may be generated by excluding sections 2, 4, 5, etc., from section 1 through section N of the content 310.

The content providing apparatus may dispose a temporally last section, for example, section N, at a last location of the modified content 320, among the plurality of sections, for example, section 1 through section N included in the content 310. Since section N corresponding to the last section is disposed at the last location of the modified content 320, a second user may view a smooth ending of the modified content 320.

FIG. 4 illustrates time information having a variety of lengths. The content providing apparatus may control a difficulty level of content based on time information. Here, the content providing apparatus may modify content so that the difficulty level of content may increase according to a decrease in time information. Conversely, the content providing apparatus may modify the content so that a difficulty level of a video game that is included in content may decrease according to an increase in time information.

For example, referring to FIG. 4, each of time information 1 410, time information 2 420, and time information 3 430 denotes time information having a different length. The time information 1 410 has a longest length and the time information 3 430 has a shortest length. Here, when the time information 3 430 is input to the content providing apparatus, the content providing apparatus may set a highest difficulty level to the content.

Although a difficulty level is divided into three stages in FIG. 4, it is only for clarity of description and thus, dividing of the difficulty level may be variously modified based on a design.

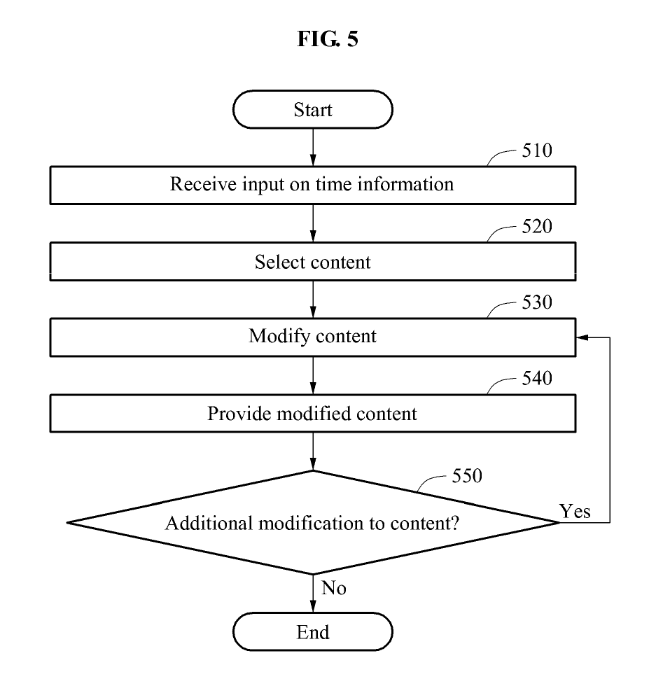

FIG. 5 is a flowchart illustrating a content providing method according to another embodiment.

The content providing method according to another embodiment may be performed by a processor provided to a content providing apparatus according to an embodiment.

In operation 510, the content providing apparatus receives an input on time information.

In operation 520, the content providing apparatus may select content based on the time information. The content providing apparatus may select content that matches the time information from among a plurality of items of contents that may be provided to a second user. The plurality of items of contents may refer to ones stored in a memory of the content providing apparatus or ones that may be received from an external server over a network.

For example, the content providing apparatus may select content to be provided to the second user by considering a difficulty level based on time information. The content providing apparatus may select content having a lowest difficulty level from among the plurality of items of contents according to an increase in time information. Here, the content providing apparatus may select a single item of content from among the plurality of items of contents by further considering a play pattern of the second user that is input in advance.

As another example, the content providing apparatus may select content to be provided to the second user by considering a playback time based on time information. The content providing apparatus may select content having a playback time that does not exceed time information and is close to the time information, from among the plurality of items of contents.

In operation 530, the content providing apparatus may modify the selected content based on the time information. The content providing apparatus may modify the content so that a playback time of the content may not exceed the time information. The description made above with reference to FIGS. 1 through 4 may be applicable to a process of the content providing apparatus that modifies the content based on the time information and thus, a further description will be omitted here.

In operation 540, the content providing apparatus provides the modified content.

In operation 550, the content providing apparatus may determine whether the content is to be additionally modified.

For example, the content providing apparatus may determine whether an additional modification to content is required based on a play pattern of the second user that performs modified content. Here, the modified content may indicate a video game. The content providing apparatus may determine whether the additional modification to the content is required by comparing points of the play pattern of the second user and predetermined threshold points. Here, the predetermined threshold points refer to points set based on a previous play pattern of the second user, and may indicate the ability of the second user on the video game. That is, when the play pattern of the second user is the same as or similar to the previous game pattern of the second user, the content providing apparatus may determine that the additional modification to the content is not required. Conversely, when the play pattern of the second user is not the same as or similar to the previous game pattern of the second user, the content providing apparatus may determine that the additional modification to the content is required.

Additionally, the content providing apparatus may determine whether there is a need to additionally modify the content, based on whether a modification on time information is input. For example, when the time information is modified by the first user, the content providing apparatus may determine that the additional modification to the content is required.

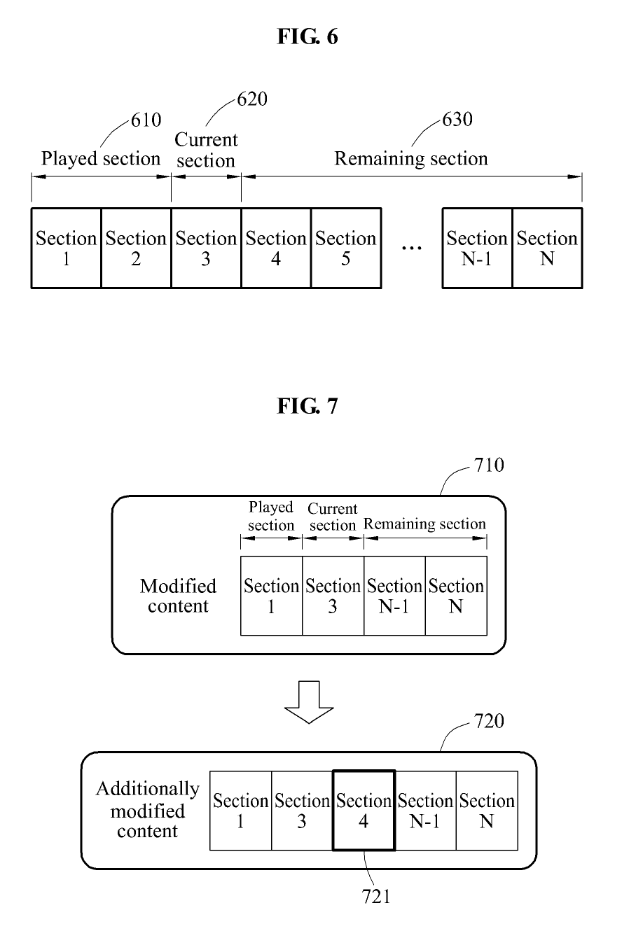

When the additional modification to the content is determined to be required, the content providing apparatus may additionally modify the content to be provided in operation 530. The content providing apparatus may increase or decrease sections included in the content to be provided, or may adjust a difficulty level of the content to be provided. The additional modification will be further described with reference to FIGS. 6 through 9.

In operation 540, the content providing apparatus may provide the additionally modified content to the second user. In operation 550, the content providing apparatus may determine whether an additional modification to the content being currently provided is required. Operations 530 through 550 may be repeated until providing the content to the second user is completed.

FIG. 6 illustrates an example of a plurality of sections included in content according to an embodiment.

FIG. 6 illustrates content that is provided to a second user. The content that is provided to the second user may be divided into a played section 610, a current section 620, and a remaining section 630. The current section 620 may indicate a section currently being viewed by the second user receiving the content, the played section 610 may indicate a section already viewed by the second user, and the remaining section 630 may indicate a section to be viewed by the second user.

An additional modification to the content being provided may be performed with respect to the remaining section 630 based on the current section 620 or the played section 610. A further description will be made with reference to FIGS. 7 through 9.

FIGS. 7 through 9 illustrate examples of additionally modifying content according to an embodiment.

FIG. 7 illustrates modified content 710 and additionally modified content 720. The modified content 710 may indicate content that is provided to a second user.

For example, when points of a play pattern of the second user is greater than predetermined threshold points, the content providing apparatus may add at least one section to content to be provided. When the ability of the second user on a video game is enhanced and accordingly, points of the play pattern of the second user increases to be greater than the predetermined threshold points, the second user may terminate the modified content 710 within a time less than time information. To prevent this, the content providing apparatus may add at least one section to the content that is provided.

As another example, when a modification for increasing time information is input from a first user, the content providing apparatus may add at least one section to content that is provided.

That is, when points of the play pattern of the second is greater than predetermined threshold points, or when a modification for increasing time information is input from the first user, the content providing apparatus may generate the additionally modified content 720 by adding at least one section, for example, section 4 721, to the modified content 710.

Here, the section 4 721 to be added may correspond to at least one section of which a similarity level with section 3 corresponding to a current section is greater than a predetermined threshold ratio.

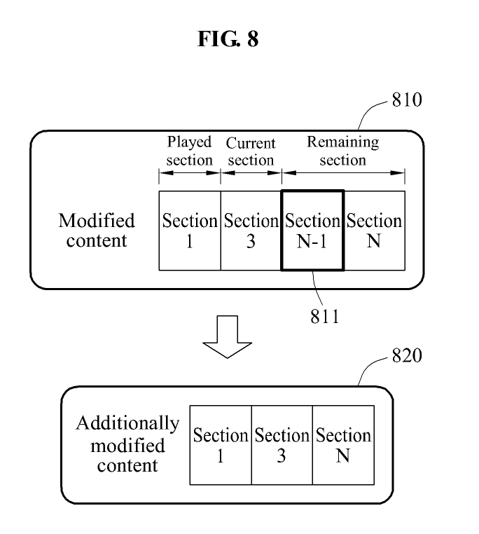

FIG. 8 illustrates modified content 810 and additionally modified content 821. The modified content 810 may indicate content that is provided to the second user.

On the contrary to the example of FIG. 7, when points of the play pattern of the second user is less than predetermined threshold points, the content providing apparatus may exclude at least one section from among sections included in content that is provided. When the ability of the second user on the video game is deteriorated, the second user may not terminate the modified content 810 within time information. To prevent this, the content providing apparatus may exclude at least one section from sections include in the content that is provided.

Also, when a modification for decreasing time information is input from the first user, the content providing apparatus may exclude at least one section from among sections included in the content that is provided.

That is, when points of the play pattern of the second user is less than predetermined threshold points, or when a modification for decreasing time information is input from the first user, the content providing apparatus may generate the additionally modified content 820 by excluding at least one section, for example, section N−1 811, from among sections included in the modified content 810. Here, at least one section to be excluded from sections included in the modified content 810 may belong to a remaining section of the modified content 810.

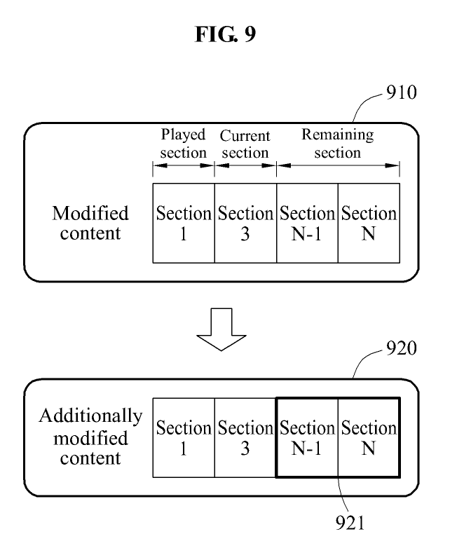

FIG. 9 illustrates modified content 910 and additionally modified content 920. The modified content 910 may indicate content that is provided to a second user.

For example, the content providing apparatus may additionally modify a difficulty level of a video game by considering a play pattern of a user that performs the modified content 910. Here, the difficulty level to be additionally modified may correspond to a remaining section 921 not performed by the user. When points of the play pattern of the second user is greater than predetermined threshold points, the content providing apparatus may decrease the difficulty level of the video game. Conversely, when the points of the play pattern of the second user is less than the predetermined threshold points, the content providing apparatus may increase the difficulty level of the video game.

As another example, when a modification for decreasing time information is input from the first user, the content providing apparatus may additionally increase the difficulty level of the video game. Conversely, when a modification for increasing time information is input from the first user, the content providing apparatus may additionally decrease the difficulty level of the video game.

The difficulty level modified in FIG. 9 may correspond to remaining sections 921, for example, section N−1 and section N, not performed by the user.

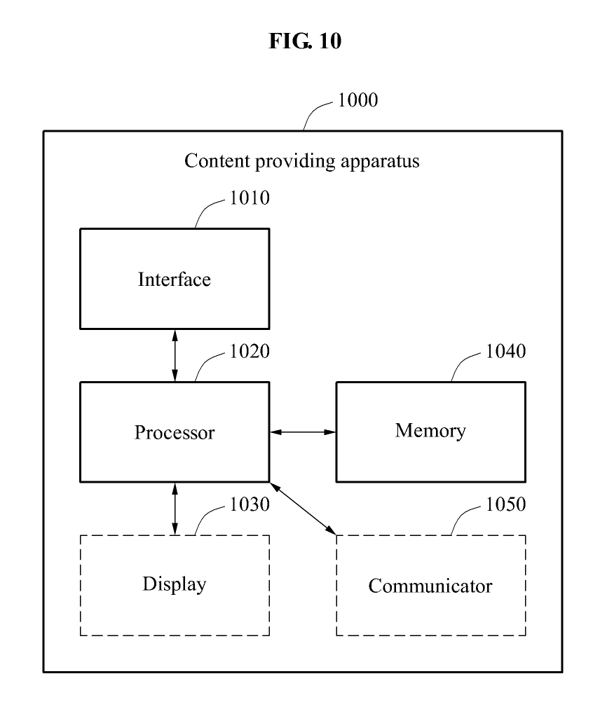

FIG. 10 is a block diagram illustrating a configuration of a content providing apparatus according to an embodiment.

Referring to FIG. 10, the content providing apparatus 1000 may include an interface 1010, a processor 1020, a display 1030, a memory 1040, and a communicator 1050.

The interface 1010 refers to an apparatus capable of receiving an input on content from a first user or a second user. The interface 1010 may include, for example, a touch screen, a keyboard, a mouse, a joystick, and the like.

The processor 1020 may receive, from the first user, an input on time information about a time in which the content is to be provided through the interface 1010. The processor 1020 may modify the content so that a playback time of the content may not exceed time information. The processor 1020 may provide the modified content to the second user through the display 1030.

The display 1030 refers to an apparatus for displaying content. Depending on examples, the display 1030 may be embedded in the content providing apparatus 1000 or may be provided outside the content providing apparatus 1000. When the display 1030 is provided outside the content providing apparatus 1000, the content modified at the processor 1020 may be transferred to the display 1030 through the communicator 1050 and may be displayed on the display 1030.

The memory 1040 may store the aforementioned content providing method. The content providing method stored in the memory 1040 may be performed by the processor 1020. Also, the memory 1040 may also store content that may be provided to the second user.

The communicator 1050 refers to an apparatus that performs communication with an external server or a third terminal over a network. Depending on examples, the communicator 1050 may not be included in the content providing apparatus 1000. The communicator 1050 may receive the content from the external server or the third terminal. Also, the communicator 1050 may transfer the modified content to the display 1030 positioned outside, so that the modified content may be displayed on the display 1030.

The description made above with reference to FIGS. 1 through 9 may be applicable to the content providing apparatus 1000 of FIG. 10 and thus, a further description will be omitted here.

The embodiments described herein may be implemented using hardware components, software components, and/or combination of hardware components and software components. For example, the apparatuses, the methods, and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software may be distributed over network coupled computer systems so that the software is stored and executed in a distributed fashion. The software and data may be stored by one or more non-transitory computer readable recording mediums.

The methods according to embodiments may be embodied in a program instruction form executable through a variety of computer devices and thereby be stored in the non-transitory computer readable recording medium. The non-transitory computer readable recording medium may include, alone or in combination with the program instruction, data files, data structures, and the like. Examples of the non-transitory computer readable recording medium include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like.

Although examples are described with reference to some embodiments and drawings, it will be apparent to one of ordinary skill in the art that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure

What is claimed is:

1. A method of providing content, the method comprising:
receiving an input on time information about a time at which content is to be provided;
modifying the content to prevent a playback time of the content from exceeding the time information; and
providing the modified content.

2. The method of claim 1, wherein the content comprises a plurality of sections, and
the modifying of the content comprises grouping the plurality of sections into at least one group based on features of the plurality of sections and modifying the content based on the at least one group.

3. The method of claim 2, wherein the features of the plurality of sections comprise information about at least one of contrast, brightness, and tone of images comprised in the plurality of sections, content description comprised in the plurality of sections, and tags preset to the plurality of sections.

4. The method of claim 1, wherein the modifying of the content comprises modifying the content to prevent the playback time of the content from exceeding the time information by excluding at least one section from a plurality of sections comprised in the content.

5. The method of claim 1, wherein the modifying of the content comprises modifying the content to dispose a section disposed at a temporally last location among a plurality of sections comprised in the content, at a last location of the modified content.

6. The method of claim 1, wherein the modifying of the content comprises controlling a difficulty level of the content based on the time information.

7. The method of claim 6, wherein the modifying of the content comprises modifying the content to increase the difficulty level of the content according to a decrease in the time information.

8. The method of claim 6, wherein the modifying of the content comprises:
controlling the difficulty level of the content by adjusting at least one of the number of enemies that appear in a shooting game, a motion speed of an enemy, and an item providing frequency in a case in which the content is the shooting game; and
controlling the difficulty level of the content by adjusting a difficulty level of a question presented in a quiz game and a time limit for solving the question in a case in which the content is the quiz game.

9. The method of claim 1, wherein the modifying of the content comprises additionally modifying the provided content based on a play pattern of a user performing the provided content.

10. The method of claim 9, wherein the modifying of the content comprises adding at least one section to the provided content in response to points of the play pattern of the user being greater than preset threshold points.

11. The method of claim 10, wherein the modifying of the content comprises adding, to the provided content, at least one selection of which a similarity with a current section of content being viewed by the user is greater than a preset threshold ratio.

12. The method of claim 9, wherein the modifying of the content comprises excluding at least one section from sections comprised in the content in response to points of the play pattern of the user being less than preset threshold points.

13. The method of claim 9, wherein the modifying of the content comprises adjusting a difficulty level of the provided content through a comparison between points of the play pattern of the user and preset threshold points.

14. The method of claim 1, wherein the modifying of the content comprises adding at least one section to the provided content, excluding at least one section from sections comprised in the provided content, or adjusting a difficulty level of the provided content, in response to an input on modification to the time information.

15. An apparatus for providing content, the apparatus comprising:
an interface configured to receive an input associated with content; and
a processor configured to modify the content in response to the input,
wherein the processor is further configured to receive an input on time information about a time at which content is to be provided, to modify the content to prevent a playback time of the content from exceeding the time information, and to provide the modified content.

16. The apparatus of claim 15, wherein the content comprises a plurality of sections, and
the processor is further configured to group the plurality of sections into at least one group based on features of the plurality of sections and to modify the content based on the at least one group.

17. The apparatus of claim 15, wherein the processor is further configured to modify the content to prevent the playback time of the content from exceeding the time information by excluding at least one section from a plurality of sections comprised in the content.

18. The apparatus of claim 15, wherein the processor is further configured to modify the content to dispose a section disposed at a temporally last location among a plurality of sections comprised in the content, at a last location of the modified content.

19. The apparatus of claim 15, wherein the processor is further configured to control a difficulty level of the content based on the time information.

20. The apparatus of claim 15, wherein the processor is further configured to additionally modify the provided content based on a play pattern of a user performing the provided content.
